(19) United States
(12) Patent Application Publication
(10) Pub. No.: US 2017/0223314 A1
(43) Pub. Date: Aug. 3, 2017

(54) Limited Access Community Surveillance System

(71) Applicant: John K. Collings, III, Mableton, GA (US)

(72) Inventor: John K. Collings, III, Mableton, GA (US)

(21) Appl. No.: 15/416,676

(22) Filed: Jan. 26, 2017

Related U.S. Application Data
(60) Provisional application No. 62/288,670, filed on Jan. 29, 2016.

(51) Int. Cl. H04N 7/18; H04N 5/33; H04N 5/44; H04W 4/22; G01S 5/18; H04M 1/725; H04W 4/02; H04N 5/232; G06K 9/32

(52) U.S. Cl. CPC H04N 7/188; H04N 7/181; H04N 5/23238; H04N 5/33; H04N 5/23296; H04N 5/44; G06K 9/3258; G01S 5/18; H04M 1/72533; H04M 1/72572; H04W 4/02; H04W 4/22; G06K 2209/15

(57) ABSTRACT

A surveillance system includes at least one controllable first video camera (422) that has a field of vision (408). A geographically-aware event indicating device (426) has a known spatial relationship to the first video camera (422). A processor (110) is in communication with the first video camera (422) and the geographically-aware event indicating device (426). The processor (110) is programmed to aim the first video camera (422) along in a direction indicated by the geographically-aware event indicating device (426) when the geographically-aware event indicating device (426) indicates an event that is consistent with predetermined criteria. A computer readable memory (112) is in communication with the processor (110) and stores video data from the first video camera (422) and sound data from the first acoustic sensor.

### CROSS-REFERENCE TO RELATED APPLICATION(S)

This application claims the benefit of U.S. Provisional Patent Application Ser. No. 62/288,670, filed Jan. 29, 2016, the entirety of which is hereby incorporated herein by reference.

### BACKGROUND OF THE INVENTION

1. Field of the Invention

The present invention relates to surveillance systems and, more specifically, to a surveillance system used in limited access environments.

2. Description of the Related Art

Limited access communities, such as apartment complexes, spend considerable sums each year relating to access. For example, repair costs for gates damaged due to cars running into them can average in excess of $40,000 per year for a typical gated apartment complex. Additionally, vehicle drivers who damage their vehicles as a result of improperly entering or exiting a gate sometimes claim that the damage resulted from a faulty gate.

Limited access communities also want to limit access only to authorized vehicles and they want to be able to provide security quickly within their boundaries.

Surveillance cameras are used by most apartment properties, yet many existing systems do little to deter or resolve events. Reasons for this include the fact that many properties are inadequately monitored. This can result in reckless behavior by tenants and visitors, damage to property and unsettled complaints by residents, which can lead to concessions being made by property managers, lease termination by dissatisfied residents and remarketing costs.

Therefore, there is a need for surveillance system that identifies vehicles entering and exiting limited access properties and that records events that it senses.

Therefore, there is also a need for a surveillance system that detects certain events, directs video cameras toward those events and that records sound and video of those events.

### SUMMARY OF THE INVENTION

The disadvantages of the prior art are overcome by the present invention which, in one aspect, is a surveillance system that includes at least one controllable first video camera having a field of vision. A sensor suite detects: an acoustic event, a direction to the acoustic event and a distance to the acoustic event, the sensor suite having a known spatial relationship to the first video camera. A processor is in communication with the first video camera and the sensor suite. The processor is programmed to aim the first video camera along in a direction indicated by the sensor suite when the sensor suite indicates that the acoustic event is consistent with predetermined criteria. A computer readable memory is in communication with the processor and stores video data from the first video camera and data from the sensor suite.

In another aspect, the invention is a limited access community security system for use in a limited access community having at least one access point. A video camera is disposed in a location so as to have the access point in view. A computer readable memory stores a database of stored license plate numbers. A processor is in communication with the video camera and that is programmed to: detect a detected license plate number of a vehicle that is in view of the video camera; compare the detected license plate number to the stored license plate numbers to determine if the detected license plate number is consistent with an unusual circumstance; and take a predetermined action when the detected license plate number is consistent with the unusual circumstance.

In yet another aspect, the invention is a thermal detection system. A wide angle reflector is mounted at an elevated position and is directed downwardly. A thermal camera is aimed at the wide angle reflector. A processor is in communication with the thermal camera and is programmed to generate a notification upon occurrence of a predetermined thermal event. The notification includes a location at which the predetermined thermal event has occurred.

In a representative example of one embodiment of a surveillance system for limited access properties, such as apartment complexes, gated communities, industrial sites and the like, the system includes at least one computer controlled camera (in one embodiment, two computer controlled cameras are used) mounted on a pole so as to be able to sense vehicles entering the property at, for example, a gate. The camera is configured to read the license plate of each entering vehicle. The data from the camera can be transferred wirelessly or via a hard wired line to a server, such as a server in a central office at the property.

The server performs a character recognition function on the license plate of each vehicle and stores the identifying character data. The server may also characterize the license plate by comparing it to a database of known license plates. This is a unique condition of a limited access property for a specific use. For example, the server can determine if the license plate belongs to a resident or an approved vendor (e.g., a plumber, electrician, package delivery vehicle, and the like) for quick entry into the property. The server can also determine if the vehicle belongs to a banned vehicle (e.g., an unapproved salesperson, a person under a restraining order, etc.) and alert security personnel or an interested resident when such a vehicle has been identified.

The video from the camera can be time stamped and stored by the server. This video can be useful, for example, in identifying vehicles responsible for gate damage upon entering or exiting the property.

The data from the cameras can be used for other purposes as well. For example, it can be used to detect when a second vehicle attempts to follow a cleared vehicle onto the premises. In such a case, if a gate comes down on a car, the video can be used for evidentiary purposes.

The video by itself or when coupled with a current sensor on the gate drive motor from the cameras can also be useful for identifying maintenance issues relating to the gate (e.g., jerkiness or other signs of wear).

The server can be employed to compare vendor invoices to records of vendor access to the property. For example, if an invoice charges for an electrician performing a service on a given date, the server can compare the invoiced date to the record of entering vehicles to determine if the electrician had actually entered the property on that date.

The server can also compare a partially read license plate to the database of known vendors and residents to complete identification of the license plate.

In another aspect, several computer controlled cameras with wireless communications capability can be placed at predetermined locations on the property. The cameras will have a remotely controlled pan/tilt/zoom capability. Directional microphones may also be employed.

In this aspect, the server can be programmed to detect certain types of noises (e.g., those associated with disturbances and accidents, screams, breaking glass, shots, and the like). When a predetermined noise is detected, the server will determine the source of the sound and direct the cameras so as to be able to record video at the place of the source. Both the audio and video can be recorded both for evidentiary purposes and current security purposes.

In one embodiment, the system can include an app for a smart phone so that certain people can interact with the system. For example, in an apartment complex, a resident can notify the system that its vehicle is entering the premises and cause the cameras to follow the resident's vehicle to the resident's apartment. Also, when the license plate reading device detects a resident vehicle entering the property the system can automatically communicate with the same residents smart phone application and instruct the phone, while on property, send its current location there by directing the cameras to view and record the phones current location to better monitor the residents. Also, this method prevents the phone from continuously using its GPS location service and thus substantially reduces battery drain for such a function. The app can also include a cluing mechanism indicating that the resident needs help from security, such as the smart phone being shaken or dropped. When such is detected, the system can notify security and inform a security officer of the location of the resident. The video and audio of the occurrence can also be stored for evidentiary purposes.

In another aspect of the invention, the recorded video can be stored with reference to the geographic area in view during the recording. The video and audio recordings are stored at the central computer with the geographic coordinates so that they may be retrieved by reference to a particular location on a map of the limited access property under surveillance. This greatly reduces the time needed to retrieve pertinent video evidence given that the moveable cameras can be self-directed to a particular view at any moment, such as by a pertinent audio event.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is an elevational view schematic diagram showing one embodiment of a surveillance system.

FIG. 2A is a plan view schematic diagram showing a second embodiment of a surveillance system during normal operation.

FIG. 2B is a plan view schematic diagram of the embodiment shown in FIG. 2 in which the system is reacting to specific situations.

FIG. 3 is a perspective schematic view of an embodiment of a surveillance system that is tracking an individual.

FIG. 4 is a schematic diagram of an event sensing unit.

FIG. 5 is a schematic diagram showing topography.

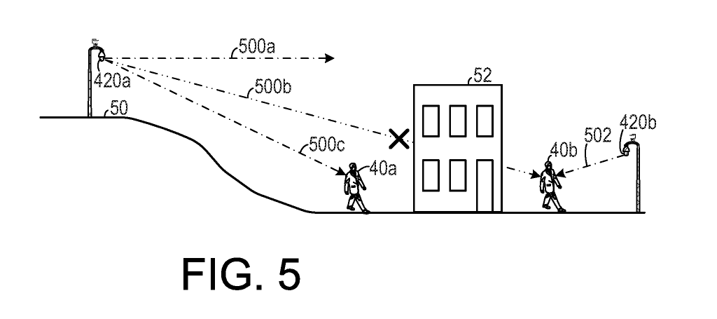

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

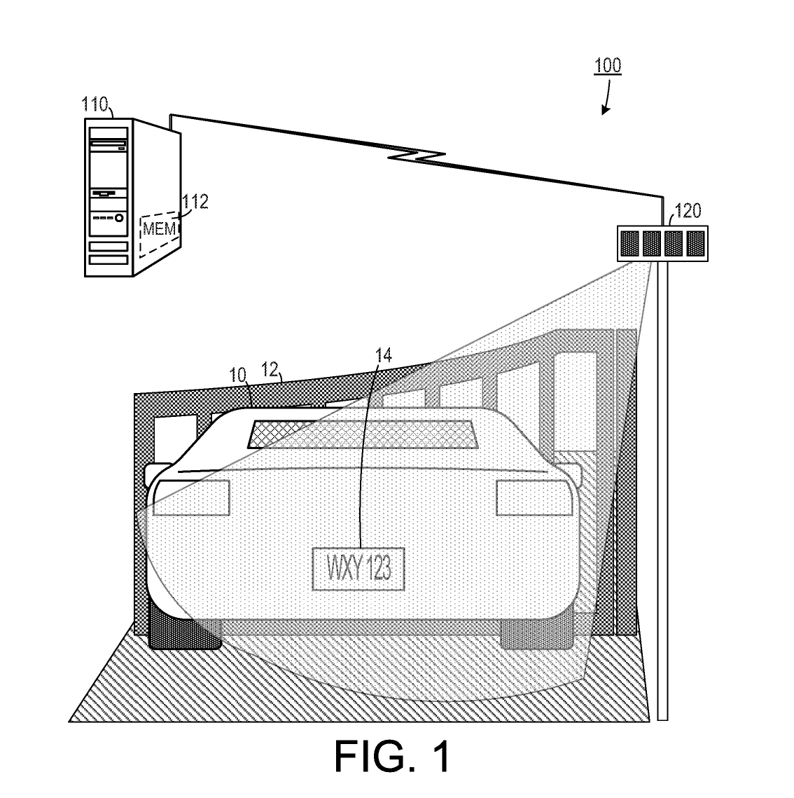

As shown in FIG. 1, one embodiment includes a controllable camera 120 in wireless communication with a server 110 (such as a server in a central office at the property) that is positioned at a limited access point 100 in the community and that is able to capture video of all vehicles 10 entering or exiting a limited access point (such as a gate 12) to a property. The camera 120 is capable of capturing an image of the vehicle's 10 license plate and the server 110 includes software that is capable of recognizing the text (e.g., the license number) on the license plate. The camera 120 is in wireless communication with the server 110 or in certain circumstances, it can be hard wired. Typically, each access point to the property (in cases where the property has multiple limited access points) would be in the field of view of at least one camera 120.

The processor of the server 110 is programmed to: detect the license plate number 14 of a vehicle 10 that is in view of the video camera 120; compare the detected license plate number 14 to a list of known license plate numbers that are stored in memory 112 to determine if a detected license plate number 14 is consistent with an unusual circumstance and take a predetermined action when the detected license plate number is consistent with the unusual circumstance. Examples of such unusual circumstances can include: the vehicle belongs to someone who has been put on a watch list (which could include a person who has been put on the watch list as a result of a request by a tenant), or has been restricted from the property; the vehicle is not on a list of authorized vehicles (such as a list of tenants or known vendors that are authorized by the community management); the vehicle is the subject of a police-generated alert; etc. The action could correspond to a classification associated with the license plate number. For example, if the license plate number is classified as “unrecognized,” “watch list” or “banned” then security personnel could be notified. If the number has been placed on a watch list as a result of a tenant request, then the system could notify the tenant of the vehicle's presence.

Once the text on the license plate is recognized, it is associated with the video, which is also time stamped and stored in a computer readable memory 112 associated with the server 110. This video can subsequently be used for evidentiary purposes, such as demonstrating that contact with the gate 12 by a vehicle caused damage to the gate 12. It can also be used to detect gate malfunction, which could be due to other causes.

The server 110 can compare the license number of a vehicle to a database and then take an appropriate action. In one example, the server can detect when an unauthorized vehicle has entered the property, such as a vehicle owned by someone under a restraining order. When such a vehicle is detected, the server 110 can notify security personnel. Also, an interested party, such as the person protected by a restraining order, can be notified by the server 110 whenever such a vehicle has entered the property. In one example, a resident can request to be notified (e.g., via a cellular telephone message) whenever a certain vehicle enters the property. However, in an apartment complex environment, the server can also prohibit a resident from being notified when another resident enters the property to prevent one resident from stalking another resident by using the system.

The license plate numbers can also be associated with a “time in” time stamp and a “time out” time stamp. This information can be used as part of an audit trail that can be associated with contractor invoices. For example, an electrician's vehicle can be logged in an out automatically and the login/logout times can be compared to charges on the electrician's invoice to determine if the charge was correct.

The server 110 can maintain a database of residents, authorized service vehicles (such as vendors), known delivery vehicles and guests. The sever 110 can automatically authorize entry of certain vehicles, such as those belonging to residents and authorized service vehicles and can also enhance surveillance for certain vehicles, such as those belonging to guests.

In one embodiment, the video can be coupled with data regarding the amount of current that is drawn by the gate motor each time the gate opens. An abnormal current draw could indicate either a jammed gate or tampering. The server 110 can alert appropriate personnel of the abnormal current draw. The alerted person can view the video to determine if the gate is malfunctioning or if someone is treating the gate improperly (e.g., stopping the gate or attempting to force entry). With an audio direction finding device the system can be programmed to view only the audio source from a pertinent direction with in the surveilled limited access property.

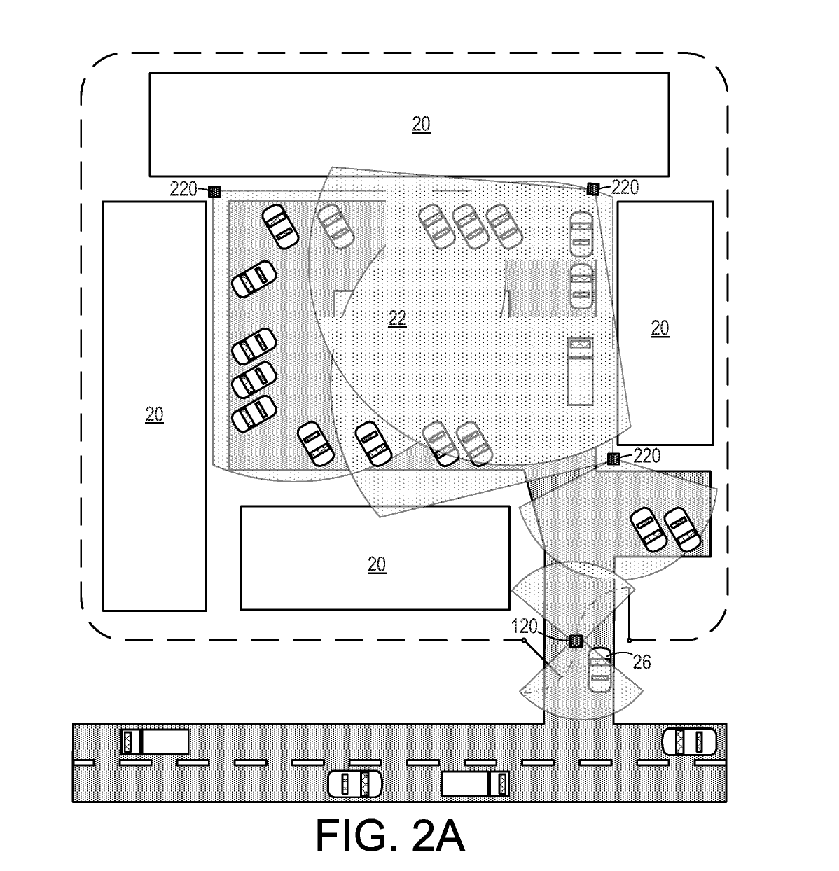

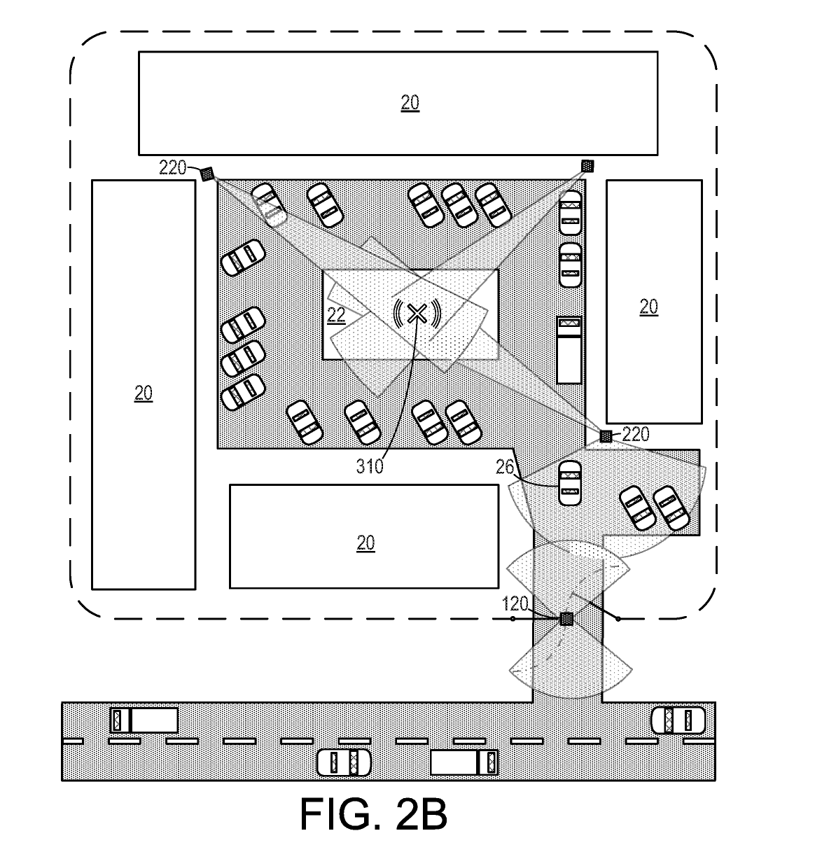

As shown in FIGS. 2A-2B, a plurality of camera/audio receiver units 220 can be dispersed about the property. Typically, the camera/audio receiver units 220 will include remotely controllable pan/tilt/zoom cameras that can be adjusted by signals received from the server 110. The camera/audio receiver units 220 will also include directional microphones that are able to determine the direction of a sound.

By dispersing several camera/audio receiver units 220 throughout the property, the system can track various items throughout the property. For example, car 26 is shown entering the property in FIG. 2A, but it is tracked after entering the property, as shown in FIG. 2B.

The server 110 is programmed to detect specific sounds through noise signature analysis and take appropriate action when such a sound is detected. For example, if it detects the sound of breaking glass, the server can triangulate on the source of the sound and direct the cameras to that source to record video for evidentiary purposes. The server can also alert security personnel to go to the source of the sound.

As shown in FIG. 2B, for example, a sound is detected at point 310. The server 110 determines the location of point 310 by triangulating the radial directions sensed by three of the directional microphones and compares the sound to its database and determines that the sound is of the type associated with an altercation. The server 110 then directs cameras in the camera/audio receiver units 220 to zoom in on the point 310 and record video from different directions. The server 110 can also notify security and supply real time video of the altercation to the security personnel.

The system can also be used to detect high volume noises. For example, if a tenant plays loud music at inappropriate times, the system can locate the source of the noise and record incidents of such loud music. This can be used as evidence in tenant disputes and eviction proceedings. It can also be used to alert security personnel to intervene.

This system can also be configured to detect sounds from predetermined locations. For example, at an apartment complex, the system can be configured to detect noise coming from a swimming pool area when the pool is closed. This can be used to notify the property manager and security personnel of unauthorized entry to the pool. The cameras can be directed to the pool to record video of the people in the pool and the video can be stored and time stamped for use by the property manager.

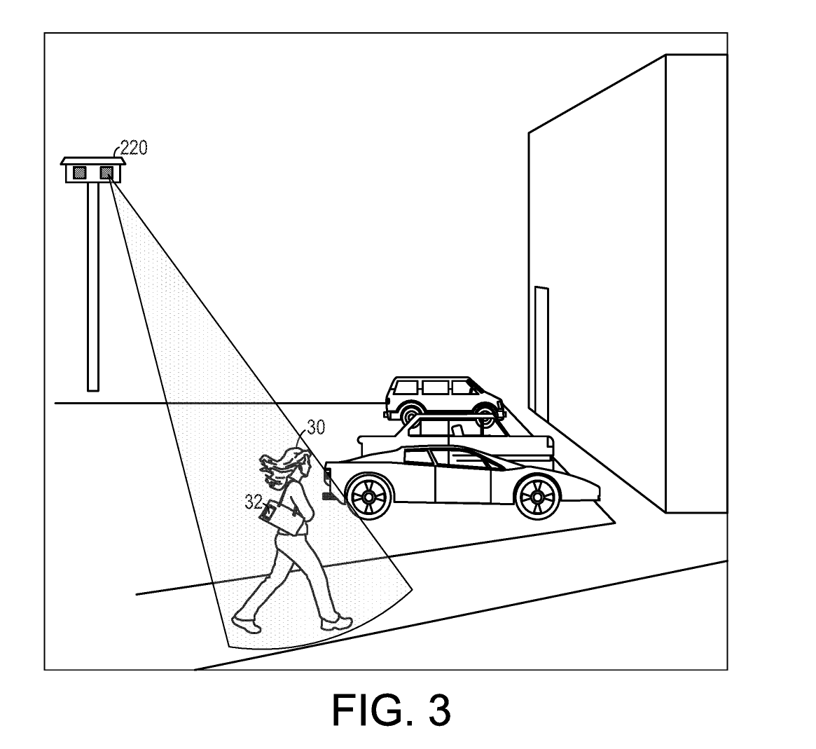

As shown in FIG. 3, the system can also respond to a tracking request by an individual. This tracking request can be automatically initiated by the system by detecting the entry of a resident by license plate reading and then instructing the corresponding resident's cell phone to send its current coordinates to the system. Also, since the resident apartment address and location may be known to the system this tracking function can be automatically stopped when the resident arrives at their apartment. For example, a tenant 30 at an apartment complex can request that her location be monitored by a camera/audio receiver unit 220 as she walks from her car to her apartment. The system will receive location data from her cell phone 32 (which would be running a cell phone application associated with the system) and a camera/audio receiver unit 220 will aim at the location of her cell phone 32 while she is walking to her apartment. If she indicates alarm, such as by shaking or dropping her cell phone 32 (which could be sensed from accelerometer data received from the cell phone 32), or pressing a button on the cell phone 32 (or through another triggering event), security can be notified of a possible altercation. Video data from the camera/audio receiver unit 220 can even be fed back to the cell phone 32, which could act as a deterrent when a tenant 30 shows the real time video to a potential assailant. Once the tenant 30 arrives safely at the location of her apartment (or other predetermined location), the system can cease tracking the cell phone 32 and reassign the camera/audio receiver unit 220. Also, the processor can receive and store video data from the camera(s) on the cell phone 32.

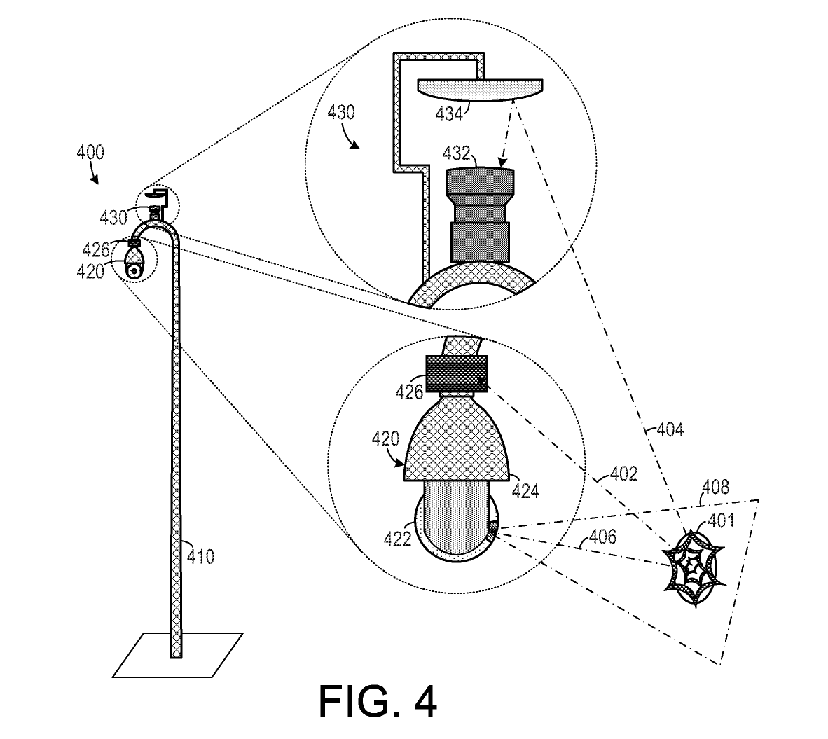

As shown in FIG. 4, in one embodiment, a direction/elevation/focus controllable video camera 420 and a sensor suite 400 can be mounted on a pole 410 (although, different sensors in the sensor suite 400 can be located at different locations). The sensor suite 400 can include a directional acoustic sensor 426 (or other type of geographically-aware event indicating device), such as a directional microphone, and an object sensor 430. The object sensor 430 can include a wide angle thermal sensor, which could include a thermal camera 432 that is aimed at a 360° wide angle reflector 434 (reflectors that cover less than 360° can be employed in certain situations, such as when mounted on a wall). All of these devices are in communication with the processor, which would be accomplished through a wireless connection or could be hard wired. The thermal sensor could also include a thermal camera with an extremely wide-angle lens (e.g. a “fisheye” lens). The video camera 420 can include a laterally rotatable mount 424 that holds a vertically rotatable camera unit 422.

Other types of object sensors could be employed to sense the distance and direction of an object 401, such as a second video camera aimed at a wide angle reflector 434, an ultra-sound detector, a radar detector, etc. In certain circumstances, thermal sensors may have difficulty distinguishing an object from its background, such as when the temperature of the object is close to the ambient temperature. In these situations, use of alternate sensor types can be used to locate the object. Such additional sensors can include video cameras, ultra sound sensors, radar sensors, etc.

In operation, when an object 401 generates a sound that is characteristic of certain criteria (such as the sound of glass breaking, the sound of an altercation—such as a verbal altercation, the sound of a vehicle accident, the sound of a gunshot, a sound that is louder than a baseline loudness by a predetermined threshold associated with a given location and time period—which could indicate a loud party, etc.), the directional acoustic sensor 426 will sense the sound 402 and then transmit the sound and a radial direction (bearing) from the microphone 426 to the source 401 of the sound event to the processor, which analyzes the sound to determine if it is consistent with the criteria and stores the direction to the sound. The thermal camera 432 will also sense a thermal image 404 of the object 401 causing the event and the processor will analyze the data from the thermal camera 432 to determine a range to the object. The processor will then direct the camera 420 to aim, zoom in on the object 401 (by setting a zoom factor, based on the distance to the object 401, that would cause the camera's field of vision to be nearly filled by the image of the object 401) and focus on it. If the object 401 moves, the processor will direct the camera 420 to track the object and will record all of the video data, sound data, thermal data and other data (if available) relating to the event and the object. The processor will calculate the spatial coordinates of spatial volume within the camera's field of view 408 and store the spatial coordinates, the video/sound/thermal data and a time/date stamp associated with the video. This data can be retrieved at a later time and used, for example, as evidence.

Data from the thermal camera 432 can be used to detect thermal anomalies associated with a property. For example, it could be used to detect the early stages of a fire by detecting a rapid heat increase through a window. If a fire is detected, the property manager can be alerted by the processor through an alarm and the fire department can be alerted. The video camera 422 can be aimed at the source of the fire. Similarly, the system can detect an abnormal hot spot in a wall, which could be an early indicator of a fault in an electrical distribution system.

As shown in FIG. 4, the system can be used in areas of varying topography (such as in the presence of hills 50) and in areas with known vertical obstructions (such as buildings 52). When a camera 420a is at an elevation that is different from that of the object 40 of interest, merely pointing the camera at the radial direction (as shown in beam 500a) would not result in the object 40a being seen by the camera. Similarly, if the object 40b is behind an obstruction 52, the obstruction 52 would block the view 500b of the camera 420a. Therefore, the processor memory stores a map of the topography and known fixed obstructions in the area of the camera 420a. Based on the information stored in the map, the processor will set an elevation (or tilt) angle and a zoom factor so that the object 40a will be in view 500c. When the processor determines that the view 500b of a given camera 420 would be blocked by an obstruction 52, it can determine if an alternate camera 420b will have an unobstructed view 502 of the object 40b. In the case shown, items 40a and 40b can represent one object at different times, such as when a person walks behind a building.

Once representative commercial embodiment can include an audio and video surveillance system for limited access properties with known residents. Limited access allows one to determine who is on property and who is off property by having license plate reading at every entrance and exit. Since these are residential properties where identification of the residents, employees and registered vendors are known, certain unknowns can be detected very easily. The system can also “learn” who are frequent guests and further reduce search for unknowns.

This embodiment can provide license plate reading for limited access (apartment) properties with known residents for the purpose of documenting vendor on premise time to use as an accounting check for vendor invoices. Using vendor transits via license plate reading results can enable the system to tie monthly invoices to “on property” visits. Specifically, for vehicle based services such as security patrols, landscaping or other services. This can be used as part of a vendor audit system.

The embodiment can include an alarm system using license plate reading. Because the system maintains a database of known residents and license plates, it allows residents to enter alerts. For example, a resident can request a text notifying that a specific individual has just entered the property, such as when someone subjected to restraining order protecting a resident has entered the property. Such an alert could be based on a license plate number. In one embodiment, residents would not be allowed to enter alerts for other residents of the same property, so as to prevent one resident from knowing when another resident is present or absent (which would prevent using the system for harassment or as an alerting tool for criminal activity).

A self-correcting license plate reading system can be included to compare license plate reads to a list of known resident plates. The system could employ neural or fuzzy logic systems to determine license plate numbers when a corresponding license plate does not exactly match any known license plate or when the camera's view of a license plate is partially obstructed. If such a match is found, then the system can auto correct the number using OCR (optical character reading software) neural network software to learn to read certain characters better next time.

One embodiment, the system can detect, identify and report wrong way travel through a gate. Using directional motion detection (pixel analysis) of a fixed camera viewing a road that has a known direction of travel (such as an entrance gate or an exit gate) the system can determine if a vehicle is improperly entering via an exit route. Using this detection with a license plate reading camera for documentation and a system that is in communications with the internet would enable the system to instantly communicate the improper entry to property authorities with identification of the offending vehicle.

One embodiment includes a system for detecting mechanical trouble or damage to traffic gates. Most entrance gates are powered by AC electric motors. By using current sensors, the system can monitor the entrance/exit gate motors current (watts) usage patterns. When a gate has mechanical difficulties (jerking, pulling, stuck) the current use pattern will fluctuate due to varying torque. The system detects these variations and via an internet link can communicate these pattern variations to property personnel as a warning of potential gate malfunction. In addition, should a vehicle hit the gate during operation an abnormal current use pattern should be produced thus setting off a notification. This information could be coupled to video for detecting and reporting gate faults and the possible causes thereof.

In one embodiment, a wide area alarm system uses moveable cameras and cell phones with GPS circuitry. Information from the cameras and cell phone can be communicated to a central computer indicating the cell phone location. The central computer can analyze the location and determine if the location is within visual view of a moveable video camera (whose location is known to the central computer) and then command the moveable camera to view and record the location of the reporting cell phone. The system can also include a function by which the cell phone owner can initiate an alarm to the central computer such as using the cell phones built in accelerometer to detect if the cell phone is dropped or shaken strenuously. This duress alarm would command the central computer to direct other moveable cameras in the area to view the location of the cell phone. Additionally, if the system where located in a plurality of properties, and if such plurality of systems are in communication with each other, then the residents of one property could use the system of another property to expand the effectiveness of the duress alarm feature.

In one embodiment, the system maps a moveable camera with a known location and with a zoom lens to equate to recording, storing and retrieving video by definition of geographic volume of space. The three dimensional volume of space can be defined as a longitude, a latitude and elevation. The central computer could have a graphic user interface that utilized maps of the area of surveillance to allow retrieval of video from movable cameras by reference to an area.

One embodiment includes a method for storing, searching, retrieving and displaying audio and video surveillance data. This embodiment can include a plurality of moveable cameras and a central computer in communication with the cameras that receives video from the cameras and analyzes the video to add, in addition to time of the video, other analyzed identifiers of the video in a database so searches of the video could be done by the other database identifiers.

One embodiment includes a method and apparatus for detecting an event or a human presence for the purpose of directing a moveable video surveillance camera. The system can combine a moveable camera that can be controlled to an absolute position of view with a plurality of event sensing sensors that can command the camera to move to view the detected event.

One embodiment includes at least one thermal sensor to detect objects and events and their direction from a controllable, moveable video surveillance camera. This embodiment combines a controllable moving camera, a thermal camera, a computer performing pixel analysis of the thermal camera and conical reflector enabling a horizontal 360° field of view. The combination results in a device that senses thermal energy in a 360° view and commands the controllable moving camera to view and record the area of the thermal energy source.

One embodiment includes an audio surveillance and alarm system for multi-family properties. This embodiment employs a plurality of audio direction finding and recording devices in known geographic locations that are in communication with a central recording computer. The system can record and track the decibel level and direction of audio events. The system can also alert property authorities if certain audio events exceed standard historical limits or preprogrammed limits. The system uses the direction of the audio event and recording to ascertain the apartment that the audio event came from.

One embodiment includes a method and apparatus for recording, documenting and evaluating human work performance. The system can include a cell phone with data transmission capability, GPS, video recorder, an accelerometer and a central computer system. Upon activation, the system can continuously record the cell phones accelerometer readings for the purpose of assessing work effort from all three axes. The system can also use the cell phone's GPS to occasionally record the phones location. When employees finish a task they evoke an application on the cell phone and record via written text, photos, audio recording or video recording an account of their work. This recording is associated with the employee's work orders on the property.

In one embodiment, the system includes a plurality of audio direction finding and recording devices in known geographic locations that are in communication with a central recording computer. The audio direction finding devices send audio recordings and its respective source direction to the central computer. The system is programmed with the geographic location of buildings and the apartments within those buildings. The system records and tracks the decibel level and direction of audio events. The system also stores a database of average audio events decibel level and direction so that it can determine, in real time, if a current audio event is within normal (or preprogrammed) decibel levels. The system can alert property authorities if certain audio events exceed standard historical limits or preprogrammed limits. The system can use the direction of the audio event and recording to ascertain the apartment that the audio event came from. The system can be used in combination with controllable moveable video cameras that can be used to video record the audio event given the direction of the audio event. Audio events can be recorded locally at the audio recording device and sent as a non-real time file to the central computer thus assuring the integrity of the audio recording. Audio events can also be analyzed at the central computer for audio signatures such as human voice, words spoken, car alarms, gunshots and the like, and if certain audio signatures are determined the central computer can notify property officials.

In one embodiment, the system will detect background noise over time (such as the sound of a nearby road) and mask noise sounds from its recording of audio. The system can also be programmed to learn which areas to which a camera is most frequently directed and then point the camera at such an area when not engaged in other activity. In some embodiments, the processor will engage in video analytics (e.g., detecting forms of a person or another object and storing detected form data with the video data). Typically, when a camera is moving from being directed to one location to another location, the video would appear as a blur and a video analytic system would perceive the video as showing motion. The system can programmed in such situations to cause video analytics to cease when movement commands are being sent to a camera and to recommence analytics once the camera has stopped moving.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A surveillance system, comprising:
(a) at least one controllable first video camera having a field of vision;
(b) a sensor suite that detects: an acoustic event, a direction to the acoustic event and a distance to the acoustic event, the sensor suite having a known spatial relationship to the first video camera;
(c) a processor that is in communication with the first video camera and the sensor suite, the processor programmed to aim the first video camera along in a direction indicated by the sensor suite when the sensor suite indicates that the acoustic event is consistent with predetermined criteria; and
(d) a computer readable memory, in communication with the processor, that stores video data from the first video camera and data from the sensor suite.

2. The surveillance system of claim 1, wherein the sensor suite comprises a first acoustic sensor that detects both a sound and a first radial direction of the sound.

3. The surveillance system of claim 2, wherein the sensor suite comprises object sensor that detects a distance to an object along the first radial direction of the sound, wherein the processor is in communication with the object sensor and is programmed to aim the camera at the object.

4. The surveillance system of claim 3, wherein the object sensor comprises:
(a) a wide angle reflector mounted in a predetermined relationship with the first video camera; and
(b) an object-sensing camera that is aimed at the wide angle reflector.

5. The surveillance system of claim 3, wherein the processor is further programmed to selectively analyze incoming data streams for a purpose of at least one of: masking, setting priority, and storage.

6. The surveillance system of claim 4, wherein the object sensing camera comprises a thermal camera.

7. The surveillance system of claim 6, wherein the processor determines a distance to the object based on data from the object sensor and sets a zoom factor on the camera based on the distance so that video from the camera includes the object and a predetermined area around the object.

8. The surveillance system of claim 6, wherein the processor determines geographic coordinates of the object based on: the radial direction of the sound, the elevation of the first video camera and a known location of the first video camera; and wherein the processor stores the coordinates in association with the video on the memory.

9. The surveillance system of claim 6, wherein the computer readable memory stores a topographic map of an area within range of the first video camera and wherein the processor is further programmed to adjust at least one of an aiming direction, a vertical elevation and a zoom factor based on topographic features between the first video camera and the object so that the object will be in the field of vision of the first video camera.

10. The surveillance system of claim 2, wherein the sensor suite further comprises a second acoustic sensor that is spaced apart from the first acoustic sensor and that is in communication with the processor and that detects a second radial direction of the sound, wherein the processor uses both the first radial direction and the second radial direction to determine an origination location associated with the sound.

11. The surveillance system of claim 1, further comprising a cellular telephone that is in communication with the processor, wherein the processor is configured to receive location information from the cellular telephone and aim the first video camera toward the cellular telephone upon occurrence of a predetermined event.

12. The surveillance system of claim 11, wherein the processor is configured to detect a license plate number of a vehicle and wherein the predetermined event comprises detecting a preselected license plate number associated with an individual who is associated with the cellular telephone.

13. The surveillance system of claim 12, wherein the processor is further configured to cause the first video camera to cease being aimed at the cellular telephone upon the occurrence of a completion event.

14. The surveillance system of claim 13, wherein the completion event comprises receiving data indicating that the cellular telephone has arrived at a predetermined location.

15. The surveillance system of claim 11, wherein the predetermined event comprises receiving a triggering event indicator from the cellular telephone.

16. The surveillance system of claim 15, wherein the triggering event indicator comprises an event indicator selected from a list consisting of: accelerometer data indicative of the cellular telephone being shaken; accelerometer data indicative of the cellular telephone being dropped; and data indicative of a manual input.

17. The surveillance system of claim 11, wherein the processor transmits video data from the first video camera to the cellular telephone, so as to allow the video data to be viewed on the cellular telephone.

18. The surveillance system of claim 11, wherein the processor receives video data from a camera in the cellular telephone and saves the video data on the computer readable memory.

19. The surveillance system of claim 1, wherein the predetermined criteria for the event comprises a criterion selected from a list consisting of: a sound corresponding to glass breaking; a sound corresponding to a gunshot; a sound corresponding to a verbal altercation; a sound louder by a predetermined threshold than a baseline loudness associated with a selected location; and a sound louder by a predetermined threshold than a baseline loudness associated with a selected time period.

20. The surveillance system of claim 1, wherein the processor stores coordinate information corresponding to a spatial volume that is in view of the first video camera and associates the coordinate information with stored video data corresponding thereto.

21. The surveillance system of claim 1, further comprising a controllable second video camera that is spaced apart from the first video camera and that is in communication with the processor.

22. The surveillance system of claim 1, wherein the processor is configured to detect a license plate number of a vehicle.

23. A limited access community security system for use in a limited access community having at least one access point, comprising:
(a) a video camera disposed in a location so as to have the access point in view;
(b) a computer readable memory that stores a database of stored license plate numbers; and
(c) a processor that is in communication with the video camera and that is programmed to:
(i) detect a detected license plate number of a vehicle that is in view of the video camera;
(ii) compare the detected license plate number to the stored license plate numbers to determine if the detected license plate number is consistent with an unusual circumstance; and
(iii) take a predetermined action when the detected license plate number is consistent with the unusual circumstance.

24. The limited access community security system of claim 23, wherein the limited access community has a plurality of access points and further comprising a plurality of video cameras, each in communication with the processor and each disposed in a location so that each of the plurality of access points is in view of at least one video camera.

25. The limited access community security system of claim 23, wherein the unusual circumstance comprises a selected one of: the detected license plate number not corresponding to a stored license plate number that is associated with an authorized license plate number; the detected license plate number corresponding to a stored license plate number that is labelled as being a restricted license plate number.

26. The limited access community security system of claim 25, wherein each authorized license plate number corresponds to at least one of a vehicle owned by a resident of the limited access community and a vehicle owned by a known vendor authorized by the limited access community.

27. The limited access community security system of claim 23, wherein the processor is further programmed to store in the database for each detected license plate number at least one of a time of entry into the limited access community and a time of exit from the limited access community.

28. A thermal detection system, comprising:
(a) a wide angle thermal sensor; and
(b) a processor in communication with the thermal sensor that is programmed to generate a notification upon occurrence of a predetermined thermal event, the notification including a location at which the predetermined thermal event has occurred.

29. The thermal detection system of claim 28, wherein the wide angle thermal sensor comprises:
(a) a wide angle reflector mounted at an elevated position; and
(b) a thermal camera that is aimed at the wide angle reflector.

30. The thermal detection system of claim 28, where the predetermined thermal event comprises sensing a temperature at the location that exceeds a baseline temperature associated with the location by a predetermined threshold.

31. The thermal detection system of claim 28, further comprising a computer readable memory in communication with the processor on which is stored data about the predetermined thermal event, including the location and a time at which the thermal event occurred.

32. The thermal detection system of claim 31, further comprising a video camera in communication with the processor and that is controlled by the processor, the processor configured to aim the video camera at the location and to store video data from the video camera of the thermal event on the computer readable memory.
